(19) United States
(12) Patent Application Publication
(10) Pub. No.: US 2011/0295624 A1
(43) Pub. Date: Dec. 1, 2011

(54) Insurance Policy Data Analysis and Decision Support System and Method

(75) Inventors: J. T. Chapin, Alpharetta, GA (US); Pravinray Gandhi, Elk Grove Village, IL (US); Christopher E. Hasbrook, Chicago, IL (US); Stephen I. Kerber, Mundelein, IL (US)

(73) Assignee: UNDERWRITERS LABORATORIES INC., Northbrook, IL (US)

(21) Appl. No.: 13/115,983

(22) Filed: May 25, 2011

Related U.S. Application Data
(60) Provisional application No. 61/347,918, filed on May 25, 2010.

(51) Int. Cl. G06Q 40/00

(52) U.S. Cl. 705/4

(57) ABSTRACT

A method for determining a fire risk score includes extracting data from real estate values, map data, FIRS data, and building data that includes an address, an age, a size, an indication whether or not sprinklers are present, and an indication whether one or more smoke detectors are remotely monitored; assigning weights to the extracted building data; identifying one or more fire stations near the building; obtaining or determining a driving time from the one or more fire stations to the building; performing a statistical regression analysis to: at least the driving time from the one or more fire stations to the building, the age of the building and the size of the building to determine an expected loss to the building in the event of a fire, and calculating a fire risk score for the building to assist an insurance company assess a risk of insuring the building.

### CROSS-REFERENCE TO RELATED APPLICATION

The present application claims the benefit of U.S. Provisional Patent Application No. 61/347,918 filed May 25, 2010, the disclosures of which are incorporated herein by reference in their entirety for all purposes.

### TECHNICAL FIELD

The present disclosure generally relates to a computerized, predictive system and method for analyzing insurance risk data and, more particularly, for predicting a real-time probability of loss events for insurance policies and determining risk reduction actions to prevent or mitigate such events.

### BACKGROUND

Insurance policies are historically replacement-driven. That is, insurance policy premiums and coverage limits are determined based on the estimated cost to replace the property covered by the policy in the event of a loss. Generally, the more valuable the property, the higher the policy premium and vice versa. Some insurance companies may consider physical property attributes such as the proximity of the property to a fire station, the presence of sprinkler systems, building construction materials, age of the building, etc., to reduce or increase coverages and premiums.

These physical attributes may mitigate the risk of a complete loss in the event of a fire. Physical attributes such as a sprinkler system and a building made of brick may mitigate the risk of a complete loss and prevent a fire from spreading to the entire property or consuming all of the property contents. Thus, these physical attributes reduce the risk that the entire property would be lost. For example, a property that includes a sprinkler system may historically experience property damage in a room and content fire that would normally have been a complete loss of the building without the sprinkler. The annual premium cost may, therefore, be reduced to reflect the expected reduced loss replacement cost due to the inclusion of the sprinkler system.

The typical, replacement-driven property analysis described above suffers from several shortcomings. For example, the analysis fails to account for the fact that fires are most often caused by owners' and residents' bad habits, common mistakes, or negligence. Two properties with different residents and a similar replacement value of $500,000 each may have completely different levels of fire risk due simply to the different individual residing in the property and their respective behaviors.

### SUMMARY

A method for determining a fire risk score is disclosed that includes extracting data from a plurality of data sources, wherein the data includes at least real estate values, map data, National Fire Incident Reporting System data, and building data, the building data including at least an address of a building, an age of the building, a size of the building, an indication whether or not sprinklers are present in the building, and an indication whether one or more smoke detectors in the building are remotely monitored; assigning weights to the extracted building data; identifying one or more fire stations near an address of the building; obtaining or determining a driving time from the one or more fire stations to the building; performing a statistical regression analysis to: at least the driving time from the one or more fire stations to the building, the age of the building and the size of the building to determine an expected loss to the building in the event of a fire, and calculating a fire risk score for the building to assist an insurance company assess a risk of insuring the building.

In another embodiment, a data analysis system and method performs a risk-driven property analysis by accounting for resident, worker, or other personal attributes, habits, and behaviors as well as material attributes in residential, commercial, and other property insurance policy coverage determinations. In a computerized system, data from various government, industry, health, and insurance sources may be combined to develop a clear understanding of the probability that a fire incident will occur at the property covered by an insurance policy due to avoidable error and unsafe behaviors on the part of the resident, workers, or others and material and contents attributes. The system may periodically or continuously rank existing insurance policies using historic, factual fire event data collected by the Federal Government and other sources to statistically determine the probability of a fire event for policyholders. Using these rankings or other attributes, the system may recommend statistically proven fire prevention actions to be taken by the resident, worker, or policyholder to reduce the risk of fire by changing behaviors and taking actions toward reducing the likelihood of a fire occurring on or in the insured's property.

In some embodiments, computer-executed instructions may extract data from various public and private sources to compare and rank policies based on the probability (or other statistical measure) that attributes of those policies (i.e., demographic, geographic, behavioral, building and/or contents materials, etc.) make that policy more or less likely to experience a loss that due to policyholder, worker, resident, and property attributes for a particular policy. Other embodiments may further analyze this data to determine one or more risk mitigation actions or habits that a policyholder, resident, or owner may adopt to reduce the likelihood of a loss occurrence.

### BRIEF DESCRIPTION OF THE DRAWINGS

FIG. 1A illustrates an exemplary block diagram of an insurance policy data analysis and decision support system;

FIG. 1B illustrates an exemplary block diagram of a computer system and network on which an exemplary insurance policy data analysis and decision support system may operate in accordance with the described embodiments;

FIG. 1C illustrates an exemplary data warehouse for use with an insurance policy data analysis and decision support system in accordance with the described embodiments; and

FIG. 2 illustrates an exemplary block diagram of a flow chart for one embodiment of a method for determining a fire risk score.

FIG. 3 illustrates another exemplary block diagram of a flow determining a fire risk score.

FIG. 4 illustrates a visual representation of a total response time determination.

FIG. 5 illustrates an exemplary expected loss index.

FIG. 6 illustrates an exemplary maximum loss index probability function.

FIG. 7-17 illustrate exemplary screen shots of a method for determining a fire risk score.

### DETAILED DESCRIPTION

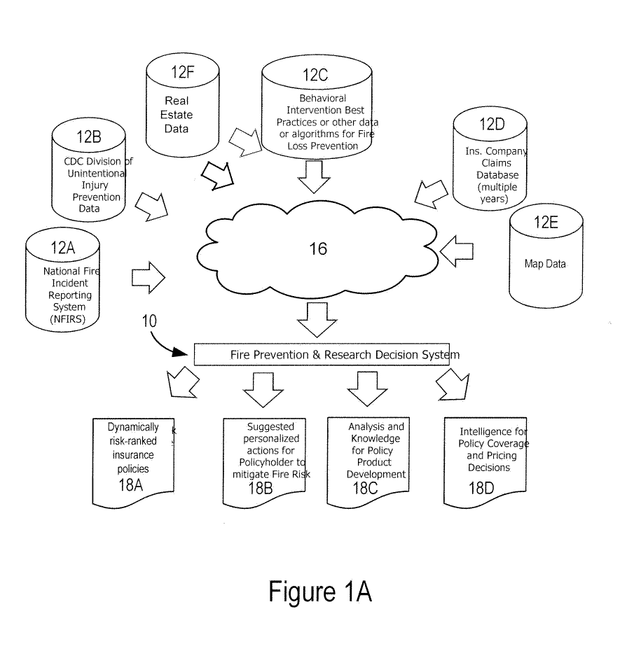

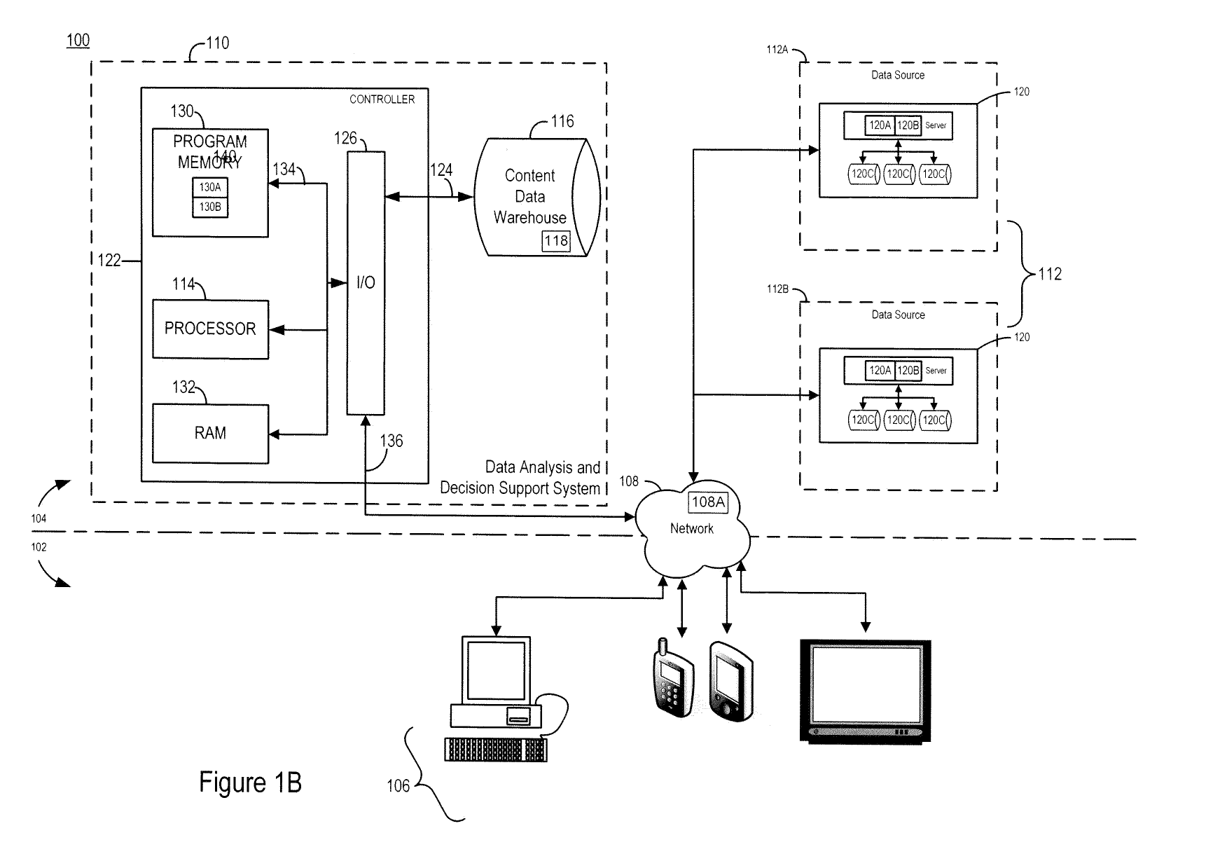

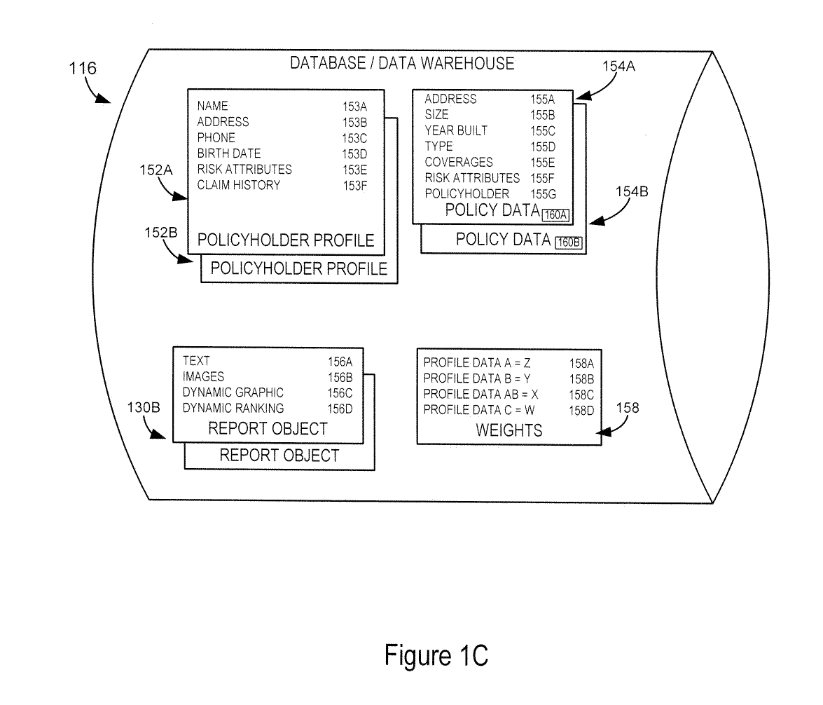

FIG. 1A illustrates a broad overview of one embodiment of a fire risk core calculation system 10. The system 10 may be communicatively linked to a plurality of data sources 12. While FIG. 1A illustrates data sources 12A through 12F, the system 10 may extract data from any number of data sources 12 that include information to calculate a fire risk core. For example, the data sources may include government data such as data from the National Fire Incident Reporting System (NFIRS) 12A, Centers for Disease Control (CDC) 12B, etc. The data sources 12 may also include data and algorithms indicating personal habits or actions that typically reduce the probability of a fire loss or fire loss best practices 12C. For example, not smoking and other behavioral “best practices” may be included in the data source 12C. Insurance company data such as an insurance company claims database 12D, a map database 12E and a real estate database 12F may also make up one or more of the data sources 12. The databases may also include state fire marshal data, city and municipal building code data, insurance data, fire department data, etc. The insurance data may include data from insurance companies as well as insurance information databanks and data services that support the insurance industry. For example, data from Verisk Analytics™ of Jersey City, N.J. may be used to provide data to the Fire Prevention and Research Decision System 10 as herein described.

Each database may be stored and distributed across multiple, physical machines. The system 10 may extract data from the data sources 12 through a network 16 (e.g., the Internet), as further described in relation to FIG. 1B, below. In some embodiments, the data extracted from the data sources 12 through the network 16 may include a unique set of database record keys that are dynamically retrieved from the data sources 12 or created based on the information retrieved from the data sources 12 and used as keys for search and/or ranking insurance policy-related data as described herein.

The system 10 may execute an algorithm or perform a method as described herein to extract data from the data sources 12 and produce reports and other information 18 using the extracted data. While FIG. 1A illustrates reports 18A through 18D, the system 10 produce any number of data reports 18 via algorithms and methods as herein described that incorporate and utilize the information from the data sources 12. For example, the reports 18 may include a list of policies 18A ranked by their individual risk for a fire loss and a list of suggested actions that a policy holder may take to mitigate fire risk 18B. The system 10 may also use the extracted data from the data sources 12 to develop and refine insurance products 18C and provide detailed information to influence policy coverage and pricing decisions 18D. Each of the reports 18 may also be based on one or more of the other reports. For example, the list of suggested actions to mitigate fire risk 18B may be based on a policy's probability of experiencing a fire loss as determined by the policy rankings of the report 18A.

FIG. 1B illustrates an exemplary computer architecture for implementing a fire risk score calculation system 10 as illustrated in FIG. 1A. In general, FIG. 1B illustrates a block diagram including computer components of the exemplary fire risk score calculation system 100. The high-level architecture may include both hardware and software applications, as well as various data communications channels for communicating data between the various hardware and software components. The fire risk score calculation system 100 may be roughly divided into front-end components 102 and back-end components 104. The front-end components 102 are primarily computing devices used by insurance company employees, agents, analysts, etc., that include web or other network-enabled devices 106. These computing devices 106 and other web-enabled devices 106 (personal computers, smart phones, PDAs, televisions, etc.) may be communicatively connected to a digital network 108. The computing devices 106 may be located, by way of example rather than limitation, in separate geographic locations from each other, including different areas of the same city, different cities, different states, or different countries.

The front-end components 106 communicate with the back-end components 104 via the digital network 108. In some embodiments, the devices 106 may use the network 108 to communicate with the back-end components via the Internet. The digital network 108 may be a proprietary network, a secure public Internet, a LAN, a virtual private network or some other type of network, such as dedicated access lines, plain ordinary telephone lines, satellite links, combinations of these, etc. Where the digital network 108 comprises the Internet, data communication may take place over the digital network 108 via an Internet communication protocol.

The back-end components 104 include an analysis and reporting system 110, and various external data sources 112 (e.g., data sources 112A and 112B). Additionally or alternatively, the analysis and reporting system 110 may be a server in communication with a private or secure LAN. The analysis and reporting system 110 may include one or more computer processors 114 adapted and configured to execute various software applications, modules, functions, routines, and components of the fire risk score calculation system 100. These various applications, etc., may, in addition to other software applications, execute a risk-driven insurance policy analysis, as further described below. The analysis and reporting system or server 110 further includes an internal data warehouse or database 116.

A database may be one or more large structured sets of persistent data. The database may also be associated with software to update and query the data. The database includes multiple tables which may each include several fields. For example, The NFIRS database may include tables for Household Fires, Wildfires, Casualties, Weather, etc. Each of these tables may have different fields that are relevant to the information stored in the table. A relational database allows users to access, update, and search information based on the relationship between data stored in different tables. For example, a relational database would allow a query of all Household Fires within a specific zip code that also included casualties where the winds averaged above 10 miles per hour. Relational databases may also query multiple databases.

The internal database/data warehouse 116 is adapted to permanently or temporarily store data, reports, and other content to be hosted by the analysis and reporting system 110. The data warehouse 116 may also be configured to store data and reports (i.e., insurer policy information, policyholder information, resident attributes, policy, resident, and property identifying information, data from the data sources 112A and 112B, etc.) within a data structure 118 for use in comparison with external data 112 to generate reports, as herein described. Some examples of data structures include a linked data structure, an abstract data structure, a concurrent data structure, an array, a list, a queue, a tree, a hash table, a graph, and a database, to name only a few. The analysis and reporting system 110 may access data stored in the internal data warehouse 116, the external data sources 112A and 112B, or a combination of the data warehouse 116 and data sources 112A and 112B when executing various functions and tasks associated with the operation of the fire risk score calculation system 100, as described herein.

Although the fire risk score calculation system 100 is shown to include an analysis and reporting system 110 in communication with four devices 106 and two external data sources 112, it should be understood that different numbers of processing systems, computers, policyholders, insurance agents, data sources, and networks may be utilized. For example, the digital network 108 may interconnect the system 100 to a plurality of data analysis and decision support systems, other external data sources 112, and a vast number of computing devices 106. According to the disclosed example, this configuration may provide several advantages, such as, for example, enabling near real-time updates of reports, policy risk rankings and information, NFIRS and CDC data, best practices data, insurance company claims data, etc.

The various data sources 112 may include one or more servers 120. The servers 120 may include information, applications, modules, routines, instructions, etc., to gather and organize the various types of data used in the fire risk score calculation 100, identify the data analysis and decision support system 110 to the data sources 112 or other external entities, and facilitate communication between the devices 106, the analysis and reporting system 110, and the data sources 112. The data source server 120 may include information, applications, modules, routines, instructions, etc., to facilitate generating a risk-driven insurance policy analysis as further explained herein. Each server 120 may be a computing apparatus that includes a memory 120A to store the information, applications, etc., and a processor or controller 1208 to execute the various applications, routines, modules, instructions, etc., as also described herein. Each server 120 may also include one or more data storage elements 120C for storing statistics and other data that may be used or extracted by the data analysis and decision support system 110 to facilitate generating a dynamic, risk-driven analysis of the policyholder and policy data as described herein. Each storage element 120C may reside physically or logically within the data source 112.

As discussed, FIG. 1B also depicts one possible embodiment of an analysis and reporting system 110 of a fire risk score calculation system 100 of the present disclosure. The analysis and reporting system 110 may include a controller 122 operatively connected to the data warehouse 116 via a link 124 connected to an input/output (I/O) circuit 126. It should be noted that, while not shown, additional databases or data warehouses may be linked to the controller 122 in a known manner.

The controller 122 includes a program memory 130, the processor 114 (may be called a microcontroller or a microprocessor), a random-access memory (RAM) 132, and the input/output (I/O) circuit 126, all of which are interconnected via an address/data bus 134. It should be appreciated that although only one microprocessor 114 is shown, the controller 122 may include multiple microprocessors 114 that include central processing units (CPUs) and graphical processing units (GPUs). Similarly, the memory of the controller 122 may include multiple RAMs 132 and multiple program memories 130. Although the I/O circuit 126 is shown as a single block, it should be appreciated that the I/O circuit 126 may include a number of different types of I/O circuits. The RAM(s) 132 and the program memories 130 may be implemented as semiconductor memories, magnetically readable memories, and/or optically readable memories, for example. A link 136 may operatively connect the controller 122 to the digital network 108 through the I/O circuit 126.

The analysis and reporting system 110 may have various different structures and methods of operation. It should also be understood that while the embodiment shown in FIG. 1A illustrates some of the components and data connections that may be present in an analysis and reporting system 110, it does not illustrate all of the data connections that may be present. For exemplary purposes, one design of a data analysis and decision support system is described herein, but it should be understood that numerous other designs may be utilized.

The program memory 130 may contain data analysis and decision support system data and objects 130A, 130B that may be used to analyze data from the data warehouse 116 and data sources 112 to generate one or more reports displayed on a computing device 106. The data and objects 130A, 130B may be stored in a variety of structures or areas within the front end 102 or back end 104 of the system 100. For example, the data and objects 130A, 130B may be stored within the data warehouse 116, a content delivery network 108A, a remote data storage facility, etc.

The data and objects 130A, 130B may include server-side or client-side computer code for facilitating the methods described herein. One example of a data analysis and decision support system object includes an instruction object 130A that includes instructions that are loaded into the program memory 130 to call various functions that are executed by the processor 114 for analyzing the data warehouse data 116 (e.g., the policyholder and policy data within the data warehouse 116), the data within the data sources 112, or other data including data that is internal or external to the system 110. Comparison of the policy data and data sources may also include creating another object. For example, an instruction object 130A that facilitates the methods described herein may generate another object, for example, a report object 130B as a result of executing the methods.

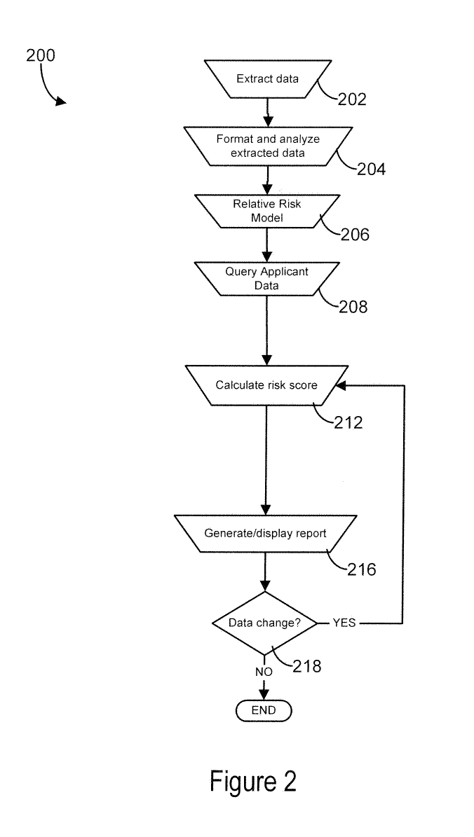

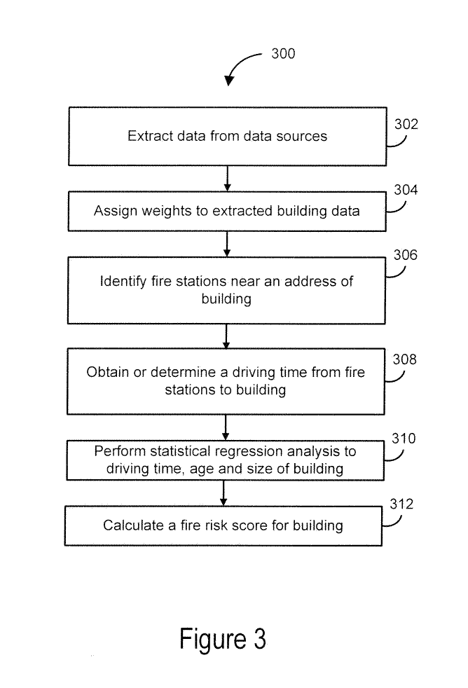

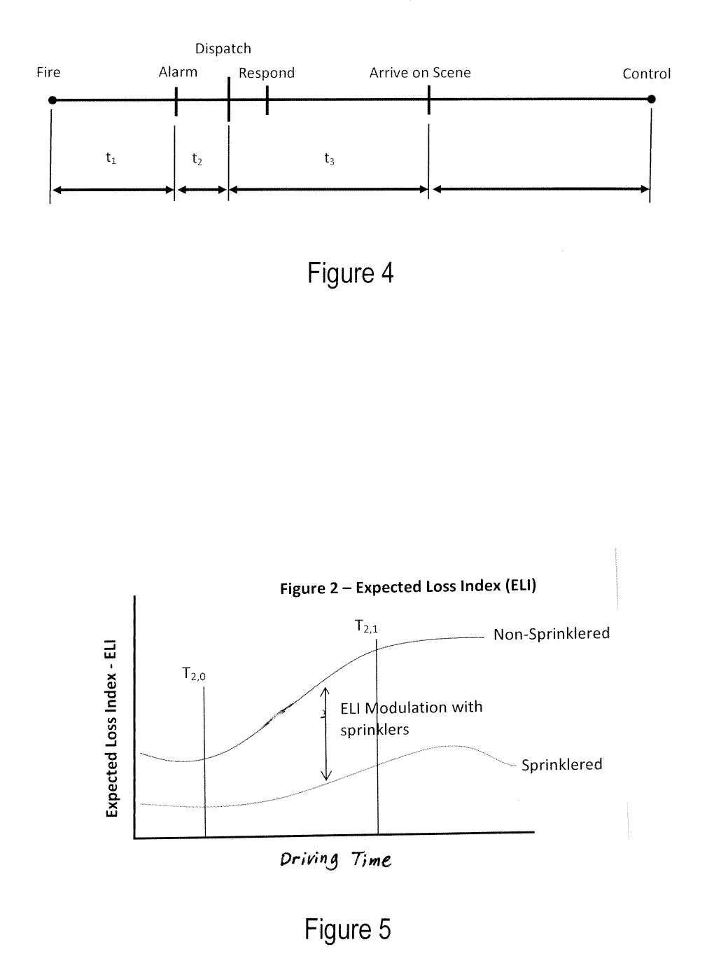

By way of example and not limitation, and as further discussed herein with reference to FIGS. 1A, 1B, 1C, and 2, an instruction object 130A may also include one or more applications, modules, routines, instructions, data, function blocks, etc., employing the elements of the controller 122 to: extract data from a data source 112 and/or data warehouse 116; format the extracted data; assign weights or other indications of importance to applicant/policyholder data; determine if data from the data sources 112 matches any of the weighted applicant data 152; determine the probability that each policyholder of an insurance entity (i.e., an insurance agency, an insurance company, a unit of an insurance company, or other logical grouping of policyholders) will experience an insured loss; rank order the insurance entity's policies according to the probability the policyholder will experience an insured loss; generate and display a policyholder report 130B that indicates the probability that each policyholder, policy, property, etc., will experience an insured loss; determine if the policy, policyholder, or other data, or the data within the data sources has changed and, if so, re-score and re-rank the policies 154.

In some embodiments, the system 110 may be configured for a specific insurer. Where the system 110 is configured for a specific insurer, the system 110 may provide report objects 130B that include a comparison of policyholder, policy, and other insurer-specific information to the information extracted from the various external data sources 112A, 112B. For example, the report object 130B may be unique to the insurer using an insurer-configured system 110 where some of the data that is compared using the instruction object 130A includes insurer-specific policyholder, policy, and other data stored within the data warehouse 116. In an insurer-configured system 110, the instruction object 130A may generate a report object 130B by holding constant insurer-specific insurance policy and policyholder data against dynamic data of the data sources 112. Thus, each time the system makes a comparison using an instruction object 130A to produce a report object 130B, the content of the report object 130B may change as a result of changing data within the external data sources 112 and the addition or deletion of policy data within the internal data warehouse 116. In still further embodiments, an instruction object 130A may include instructions to rank policy data stored within the data warehouse 116 according to the probability that each policy will experience a fire or other particular type of loss as compared to the data extracted from the data sources 112 and the various reasons recorded within the data sources for historical fire and other losses. This ranking may be included in a report object 130B. For example, comparison of a first policy's data from the data warehouse 116 to data within one or more of the data sources 112A and 112B may reveal that the first policy is more likely to experience a loss than a second policy. Thus, each set of policy data within an insurer-configured system 110 may be ranked according to that policy's risk for experiencing a loss covered by the policy.

While the embodiments described herein are generally directed to a system and method for ranking real property (i.e., building) insurance policies (i.e., residential, commercial, and industrial property), the described embodiments may apply equally to other types of property policies. For example, in a commercial or industrial setting, property may be at risk for experiencing an insured loss due to individual and collective attributes of employees. The data described below as policyholder 152 and policy 154 data may also include employee, worker, resident, building material, contents, and other records including material, demographic, geographical, or behavioral attributes.

FIG. 1C illustrates one embodiment of a database or data warehouse 116. As described above, the data warehouse may include insurer-specific data including policyholder and policy information as well as various objects including report objects 130B and other data that may be used compare and rank policy data in a risk-driven insurance policy evaluation. For example, the data warehouse 116 may include various policyholder 152 and policy 154 data and other information. In some embodiments, the policyholder data 152 includes material, demographic, geographical, or behavioral attributes that may influence the probability that a policyholder may personally experience or cause an insured loss. For example, the policyholder profile data 152 may include a policyholder's name 153A, address 153B, phone number 153C, and birth date 153D. Other policyholder data may include policyholder risk attributes 153E and a claim history 153F. Policyholder risk attributes 153E may include data that indicates the policyholder, residents, or any individual connected to the policy (e.g., persons residing in, working in, or otherwise using the property) have an increased or decreased probability to experience a fire or other loss to the insured property. The policyholder risk attributes 153E include demographic (e.g., marital status, age, etc.), geographic (e.g., urban, suburban, rural, etc.), and behavioral (e.g., high risk hobbies, smoking or tobacco use, alcohol use, drug use, etc.) attributes of the policyholder or other residents. The claim history 153F may also indicate a type of risk for the insurer as policyholders with more numerous claims may indicate a higher probability of experiencing a property loss than policyholders with fewer claims.

Policy data 154A or 154B may describe the current insurance policies of various policyholders corresponding to the policyholder profiles 152A,152B, etc. Where the policy covers real property, the policy data 154A and 154B may include a property address 155A, a property size 155B, a year built 155C, a property type 155D, and a type of coverage 155E. For example, a type of coverage may include a type of loss event such as fire, wind, water, etc., and may also include limits for the coverage 155E such as dollar amount, time period, etc. Other policy data may include policy risk attributes 155F that include any data that may indicate a higher or lower probability for a loss due to attributes of the property insured. For example, the policy risk attributes may include the age and type of building materials of a house (i.e., dry wall, lath, brick, wood, metal, etc.), the age and type of building structure (i.e., ranch, a-frame, duplex, masonry construction, wood framed construction, etc.), and the age and type of building contents (i.e., synthetic or natural material, hazardous materials storage, etc.), the presence or absence of a sprinkler system, a fire alarm system, or other hazard mitigation, prevention, or warning system. The policy data may also include an indication of a policyholder 155G corresponding to a policyholder profile 152A, 1528, etc. The policyholder data 155G of the policy data 154A or 1548 may be used as a key for determining a risk ranking of the policies as herein described.

The data warehouse 116 may also include a report object 130B as generally described above. The report objects 130B may be generated by comparing data from the policyholder profiles 152 and policies 154 to data within the various external data sources 112, as described herein. The report objects 130B may include various data to display a risk ranking, data that may be analyzed by an insurance entity, suggestions for changes to the policyholders behavior or property to mitigate risk (e.g., data compiled from Underwriters Laboratories, Inc. or other safety and risk mitigation experts, as extracted from data source 12C) or other information regarding policies, policyholders, or potential policyholders in a risk-driven analysis. In some embodiments, a report object 130B may include a text portion 156A, an image 1568, and one or more dynamic objects such as a dynamic graphic 156C and a dynamic ranking 156D. The dynamic objects 156C and 156D may include data and graphic representations of data (e.g., bar graphs, pie charts, line graphs, etc.) stored in the data warehouse 116 and the various data sources 112. The dynamic objects 156C, 156D, may be linked to data from the warehouse 116 or data sources 112. If the data within the data warehouse 116 or the data source 112 changes, the dynamic object(s) may reflect that change by, for example, changing a ranking value, changing a graph value, etc., to mirror the effect that the data change has on the report object. Thus, the methods described herein may continuously compare and rank policies within the data warehouse 116 against the data within the data sources 112 (i.e., NFIRS, CDC, etc.) to graphically represent the probability of fire or other loss events for each policy. In some embodiments, the report object 130B includes data within a database table including a plurality of records that include a plurality of fields. The report object 130B data may include data that is retrieved from the various data sources 12 and used as keys to search for and rank order policy data from the data warehouse 116 as herein described. Further, the instruction object 130A may be configured to search for fields within the data sources 12 that match particular data within a subset of policies 154 to produce a report object 130B, as further described with reference to the method 200, below.

The data warehouse 116 may also include weights 158 related to the policies 154 in general. The weights 158 may include a value or other indication of a degree that a particular piece of policy data 154, policyholder data 152, combination of policyholder data 152, etc., may influence a dynamic graphic 156C, dynamic ranking 156D, or other report object elements 156. In some embodiments, the weights 158 are used to calculate and rank order a risk score 160 for each policy.

As Illustrated in FIG. 2, a method 200 may compare the applicant and/or policyholder and policy data (e.g., data within the data warehouse 116) to data that is stored in the data sources 112. The method 200 may, thus, generate a dynamic, risk-driven analysis of the building corresponding to the policy or application. The method 200 may include one or more functions that may be stored as computer-readable instructions on a computer-readable storage medium, such as a program memory 130. The computer-readable instructions include the instruction object 130A described above as well as various modules and functions described herein. The instructions are generally described below as “blocks” or “function blocks” proceeding as illustrated in the flowchart illustrated by FIG. 2 and may generally be described as a risk analysis engine including instructions stored in the program memory and executed on the processor 114. While the blocks of the flowchart are numerically ordered and described below as proceeding or executing in order, the blocks may be executed in any order that would result in performing a dynamic, risk-driven analysis of the policyholder and policy data.

At block 202, the method 200 may extract data from one or more of the plurality of data sources 12 in general and data source servers 120 in particular. In some embodiments, the method 200 may extract fire incident data from a NFIRS data source 12A including records and fields within the data source that include data that matches particular records and fields of the policyholder data. For example, the NFIRS data source 12A may include zip code, address, and other data that matches policyholder data within the data warehouse 116. Additionally, the NFIRS data source may include fire cause codes and other data that may be used to indicate whether any particular piece of policyholder data increases or decreases the probability that the policyholder may experience a fire loss. The extracted data may be stored in the data warehouse 116, the program memory 130, or another element of the system 110. The system may also extract real estate values, map data, National Fire Incident Reporting System data, city and municipal building codes, insurance claim data, and state fire marshal data.

At block 204, the method 200 may format and analyze the data extracted at block 202. This may include reviewing every family for a predetermined number of years, such as every four years. In some embodiments, the extracted data may be re-formatted to match a schema of the policyholder 152 and policy 154 data stored within the data warehouse 116.

At block 206, the method 200 may apply a relative risk model, which will be described in more detail below and may include, for example, assigning weights 158 to data within a policy/applicant record 154, for example, record 154A. In some embodiments, the method 200 may launch an interface to allow a user to enter a weight for each user-selected element of policy 154 and policyholder 152 data.

At block 208, the method 200 may query applicant data to determine if any applicant data matches any of the data extracted from the data sources 112. For example, a particular policy record 154A may include a policyholder reference 155G to particular policyholder data 152 that matches statistically significant historical attributes from fire loss incidents as extracted from a NFIRS data source 12A. Because the policy 154A in general and the policyholder data 152 in particular matches a high number of fire loss historical attributes, that particular policyholder may be described as having a correspondingly high risk for experiencing a future fire loss.

If the policy 154 or policyholder 152 data matches the extracted data, then the method 200 may calculate a risk score 160A for the policy record 154A at block 212. The risk score 160A may include a weighted sum, mean, median, or other value that indicates a statistical measurement indicating an increased probability that that the particular policy 154A will experience a fire loss or other loss covered by any of the policy's coverages 155E. In some embodiments, the weight assigned to the particular policy data element (as described above in relation to block 206) may be multiplied by the number of loss incidents recorded in the data sources 112 that include that same policy data element (i.e., policyholder risk attributes 153E and policy risk attributes 155F). These products for each matching policy data element 154 may then be added together or otherwise mathematically and statistically manipulated to determine a final risk score 160A for the policy 154A. This will be described in more detail below.

The method 200 may generate a report object 130B that indicates a fire risk score, as well as suggestions for techniques, changes in behavior, modifications to the property, etc., that the applicant/policyholder may employ (as describe above in relation to report object 130B) to reduce the applicant's/policyholder's risk of loss.

The method 200 may display the report 130B at block 216. In some embodiments, the report 130B is displayed on the computing device 106.

At block 218, the method 200 may determine if the data within the data sources 112, the data within the policy 154, the policyholder profiles 152, etc., has changed to indicate that the risk score is no longer accurate. For example, the data source 112 data may change to indicate that policyholders including a particular risk attribute 152E that own a particular policy type 154D are experiencing a greater or fewer number of losses than before. Further, the system may re-weight policy data 154 as described above in relation to block 206. If the data has changed to indicate an inaccuracy in a current ranking of the policies, the method may return to block 212 to re-calculate the risk score to reflect the increased or decreased risk reflected in the changed data.

As described above, a data analysis system and method may perform a risk-driven property analysis by accounting for policyholder and resident attributes or habits, property risk attributes, and other factors in insurance policy coverage determinations. Data from various government, industry, health, and insurance sources may be combined to develop a clear understanding of the probability that a loss will occur at the property due to avoidable error on the part of the resident, policyholder, or others as well as policy risk attributes including attributes of the property and contents insured under the policy. The system may provide a more accurate evaluation of insurance policies than replacement-driven analyses by periodically or continuously ranking a policy's risk of loss using historic, factual loss event data collected by governmental agencies and other groups. The data may statistically determine the probability of a fire or other loss event for risk-ranked policyholders. Further, the rankings may be used to recommend statistically proven loss prevention actions to be taken by the resident.

FIG. 3 illustrates another exemplary flow chart of a method 300 for determining a fire risk score that includes extracting data from a plurality of data sources, wherein the data includes at least real estate values (from Zillow.com, for example), map data (Yahoo maps, Google maps, etc. for determining/retrieving a driving distance and driving time from a fire station to a building), National Fire Incident Reporting System data, city and municipal building code data, insurance claim data, state fire marshal data and building data, the building data including at least an address of a building, an age of the building, a size of the building, an indication whether or not sprinklers are present in the building, and an indication whether one or more smoke detectors in the building are remotely monitored (block 302).

The method 300 may also assign weights to the extracted building data (block 304) and identify one or more fire stations near an address of the building (block 306). The method 300 may then obtain from a map database or determine, based on retrieved map data, a driving time from the fire stations to the building (block 308), perform a statistical regression analysis to: at least the driving time from the one or more fire stations to the building, the age of the building and the size of the building to determine an expected loss to the building in the event of a fire (block 310), and calculate a fire risk score for the building to assist an insurance company assess a risk of insuring the building (block 312).

The fire risk score calculation system 100 may use a combination of historical fire incident data from sources such as the NFIRS, and NFPA analysis reports. The model may be a regression model to predict an Expected Loss Index (ELI), and Maximum Loss Index (MLI) using key variables such as the driving distance from fire stations, age of the home, and size of the home. The Indices may be modulated using various factors that influence fire growth in a home. These variables may include, for example, driving distances from nearby fire stations, the age of the building and the size of the building. The factors may include, for example, the presence or absence of fire sprinklers, whether smoke detectors in the building are remotely monitored, the location of the building including the number of nearby fire losses, a percentage of loss distribution and a distance to the three nearest fire stations, whether or not the ceiling in the basement is covered with drywall and the extent that is covered, and the NEC code adoption year.

FIG. 4 illustrates a visual representation of a total response time determination. The total response time, T, is the time fire service personal will take to arrive at the fire scene once the fire has started. It may be expressed as the sum of individual times as illustrated in FIG. 1. In other words, T=t₁+t₂+t₃; where T is the total response time (min), t₁=time to detect the fire and call 911, t₂=time for 911 to send the call to an appropriate fire station to respond (notify fire station), and t₃=time for fire service to arrive at the fire incident scene.

The time t₁, depends upon a number of factors such as when the fire is detected after initiation, and the time to call 911 for fire service assistance. This variable may be deduced as a probability function using fire incident data from NFIRS, as well as fire re-creation research. Research may also provide a range of values for t₁ when smoke alarms are present. When a smoke alarm is monitored remotely, the values for t₁ may range from 1 to 9 minutes depending upon the origin of the flaming fire.

The time t₂, is the time for 911 to call/notify the appropriate fire station to respond. US national standards such as NFPA Standard 1221 “Installation, Maintenance, and Use of Emergency Services Communications Systems” define the maximum value for t₂=60 s.

The time t₃ is fire service response time=60 seconds (NFPA 1710 “Organization and Deployment of Fire Suppression Operations, Emergency Medical Operations, and Special Operations to the Public by Career Fire Departments)+Driving Time, calculated from a program utilizing driving road speed limits or simply retrieved from a mapping database. As per NFPA 1710, the goal for fire emergency response is to arrive at the scene within 6 minutes after the 911 call is made. That is, t₂+t₃≦6 min.

FIG. 5 illustrates an exemplary Expected Loss Index (ELI). The Expected Loss Index is an averaged property loss index. The ELI is a function of Driving Time, T₂=t₂+t₃; age of home (Age); and Size of home (Size). Thus, ELI=f(T₂, Age, Size). When Driving Time≦T_{2,0}, ELI=ELIₒ. When T_{2,0}≧T₂>T_{2,0}, ELI=ELIₒ+DxT^{a}×Age^{b}×Size^{c}, where D, a, b, and c are determined using, for example, a multi-variate regression analysis. Those of ordinary skill in the art will readily recognize that other methods of regression analysis or statistical computations may be applied. When T₂>T_{2,1}, ELi=ELiₘₐₓ.

The ELI may be modulated if residential/building sprinklers are installed, resulting in a reduction of the ELI. Typical historic fire incident data shows that this amount is approximately 15%. Thus, The ELI (with sprinklers)=ELI (without sprinklers)−15.

Modulation may also be applied for any address location (ZIP specific) based upon historic fire incidents and proximity to fire stations; NEC code adoption year. Fire re-creation research has also shown that losses are lower when basement ceilings are protected with gypsum drywall. The amount of modulation is calculated based upon the home size and the size of unfinished portion of the basement.

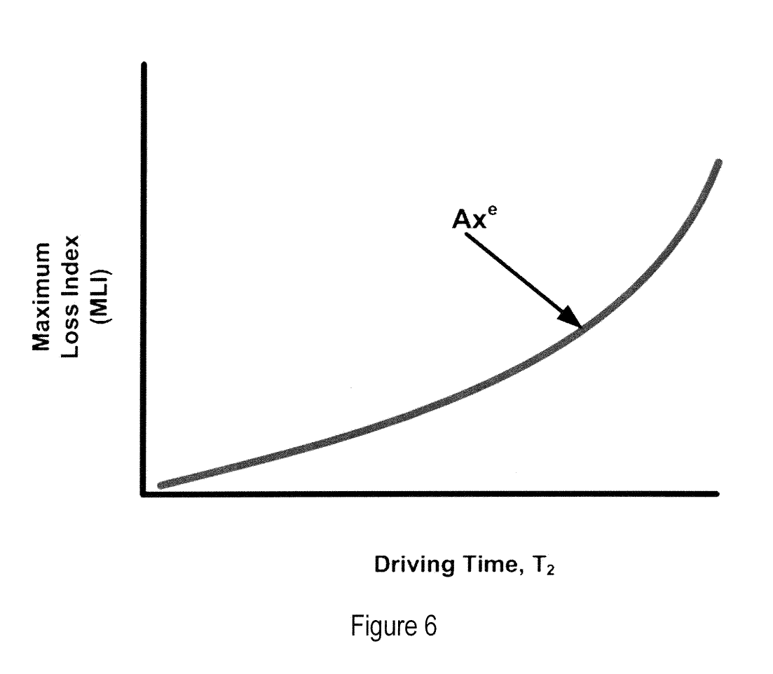

FIG. 6 illustrates an exemplary maximum loss index probability function. The Maximum Loss Index (MLI) is the probability of total loss of a building in the fire. Using historical fire incident data, the probability function of the total response time may be determined using statistical regression analysis of historical data and shown in a form of the function MLI=A(T₂)^{e}. Where A and e are derived from historical fire loss data (NFIRS) and from fire safety research data.

The MLI is also modulated based upon factors such as (i) sprinklers; (ii) NEC code adoption year in the community; (iii) Location (zip specific); and (iv) size of basement and area of basement not area of unfinished basement not protected by gypsum wallboard.

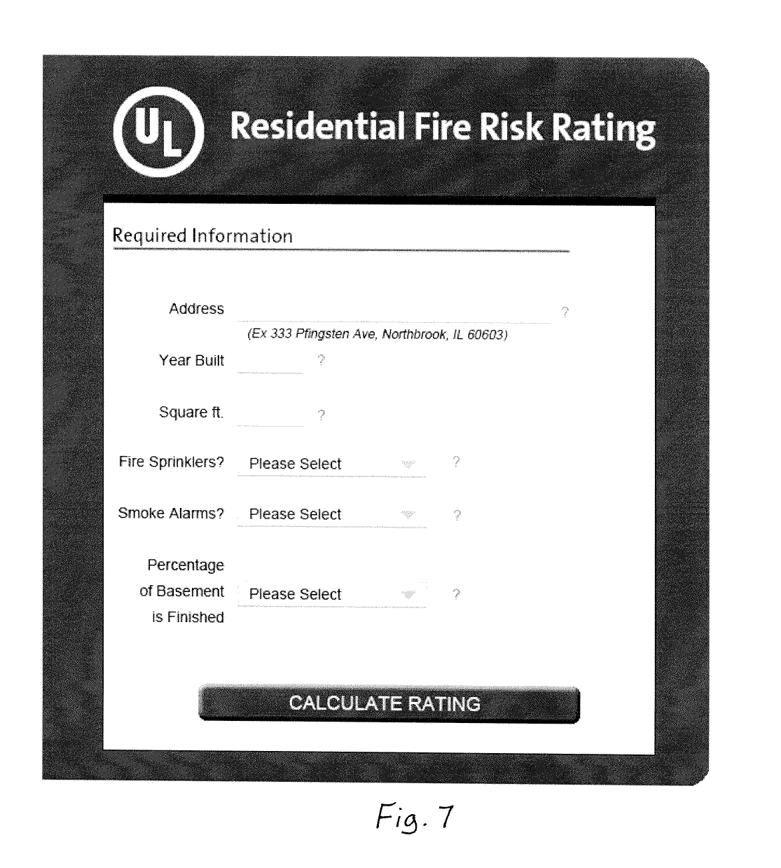

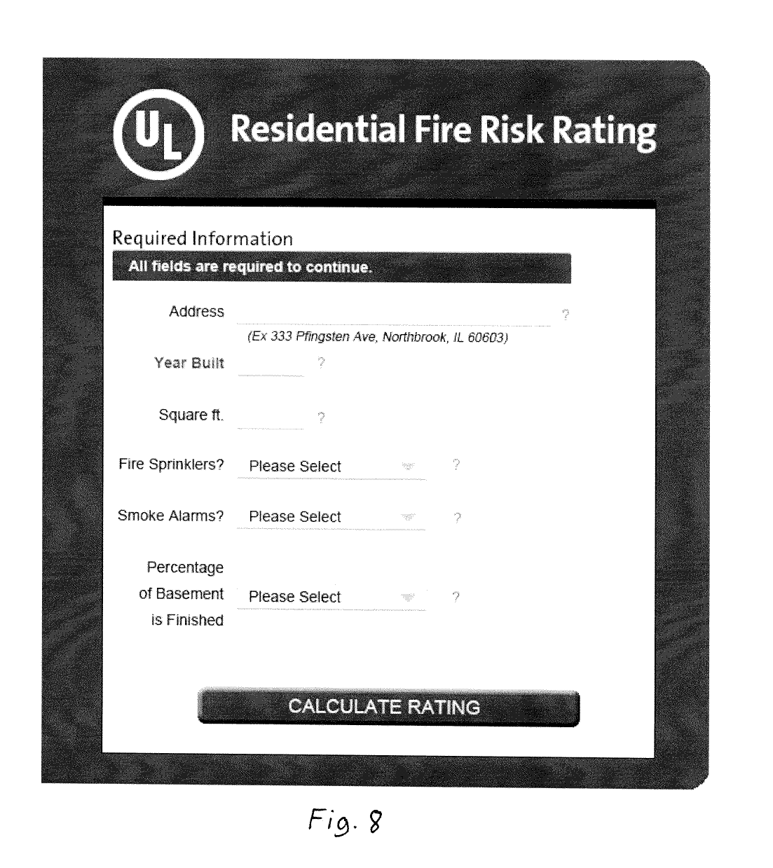

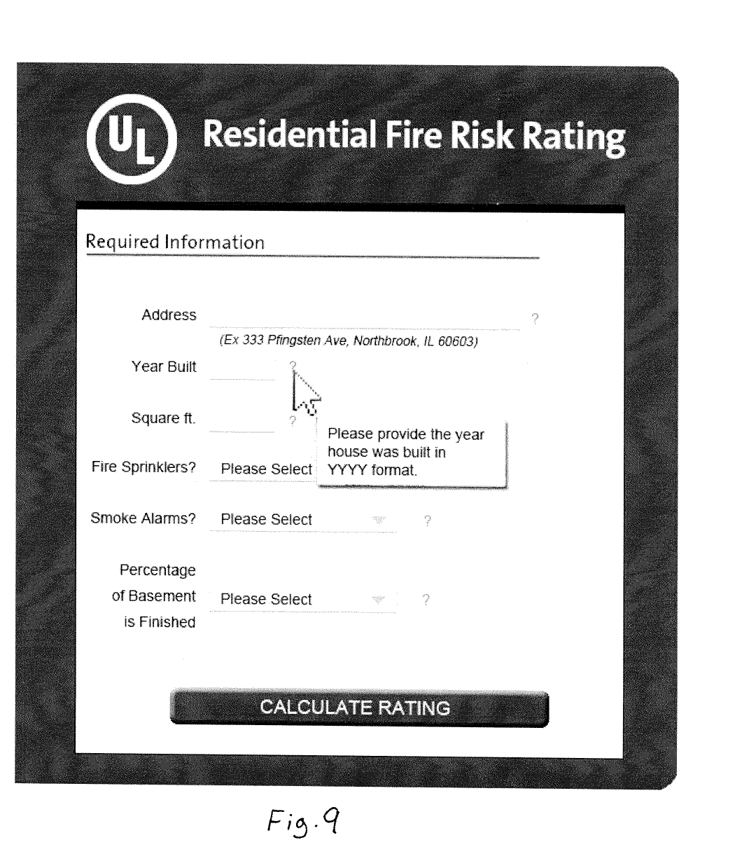

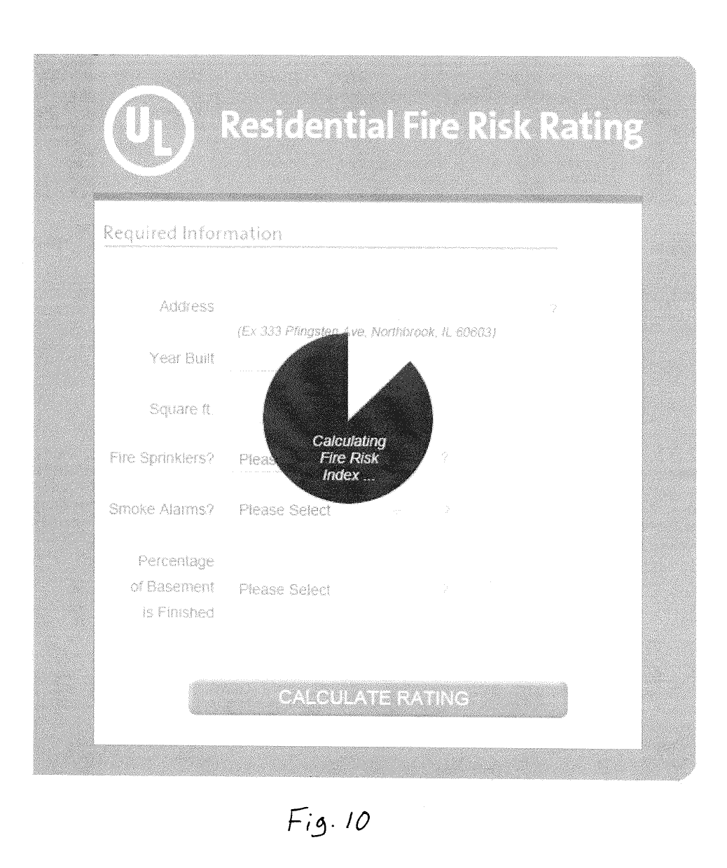

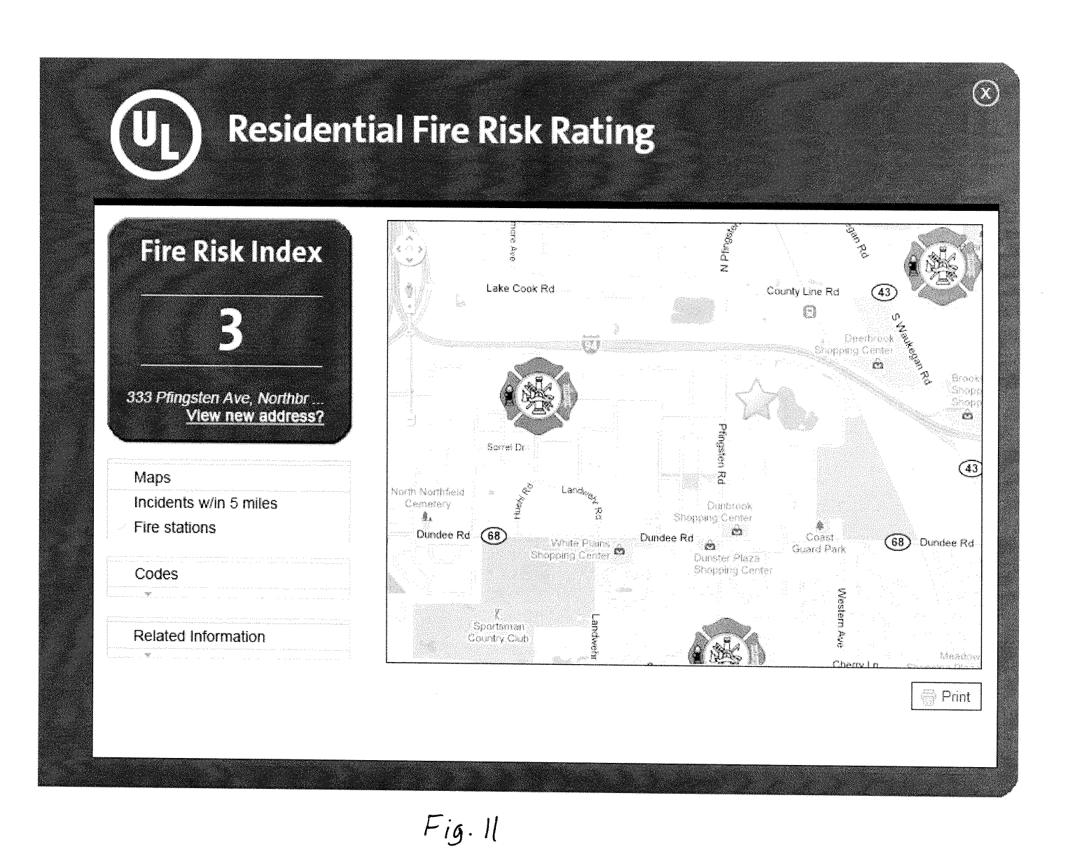

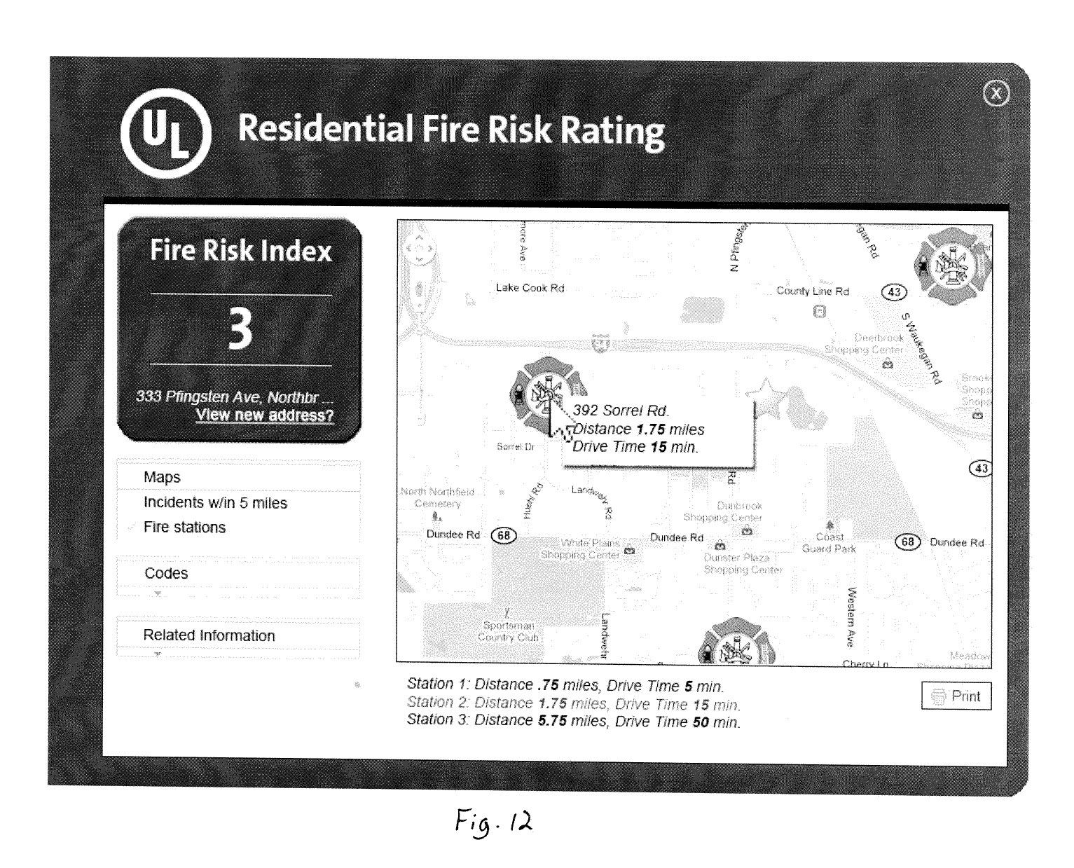

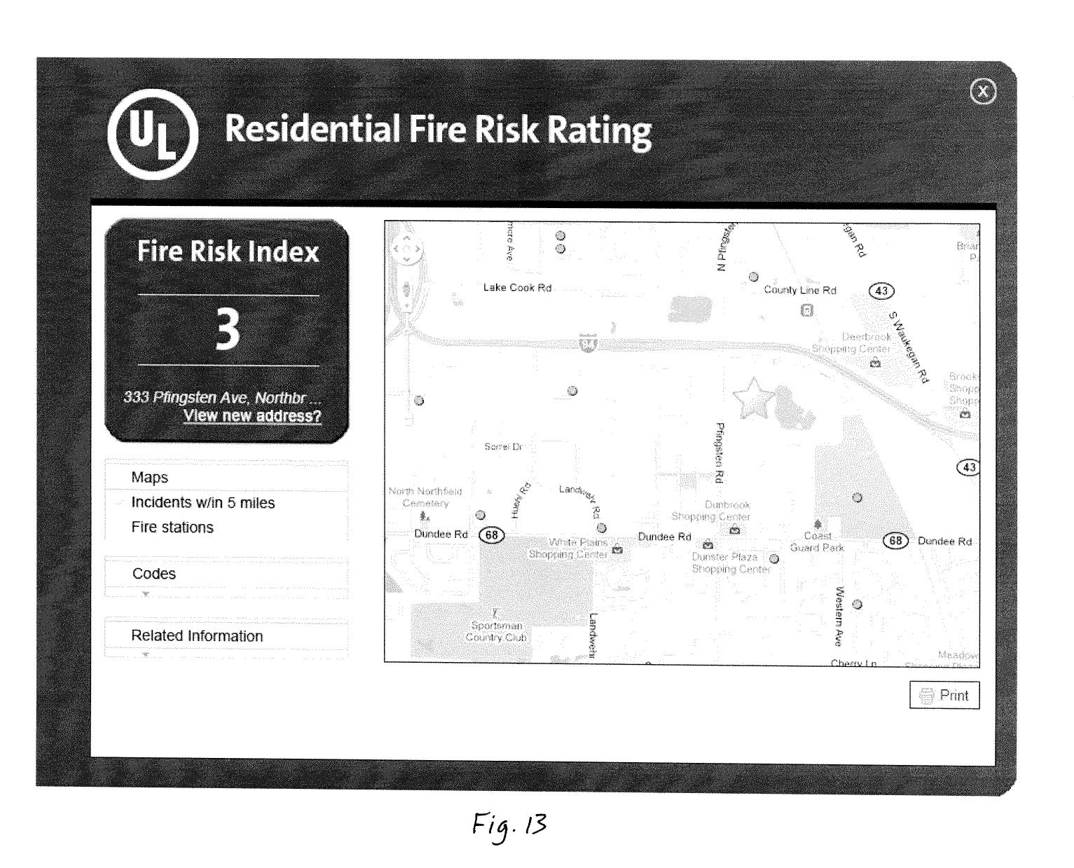

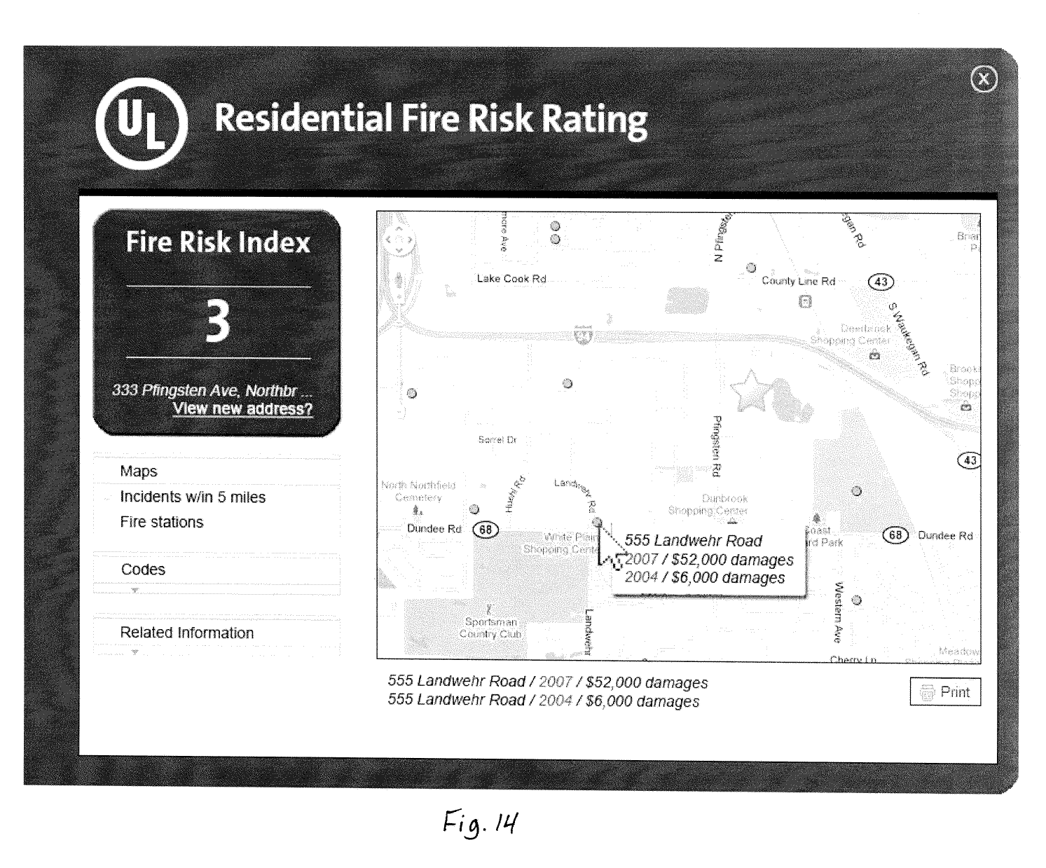

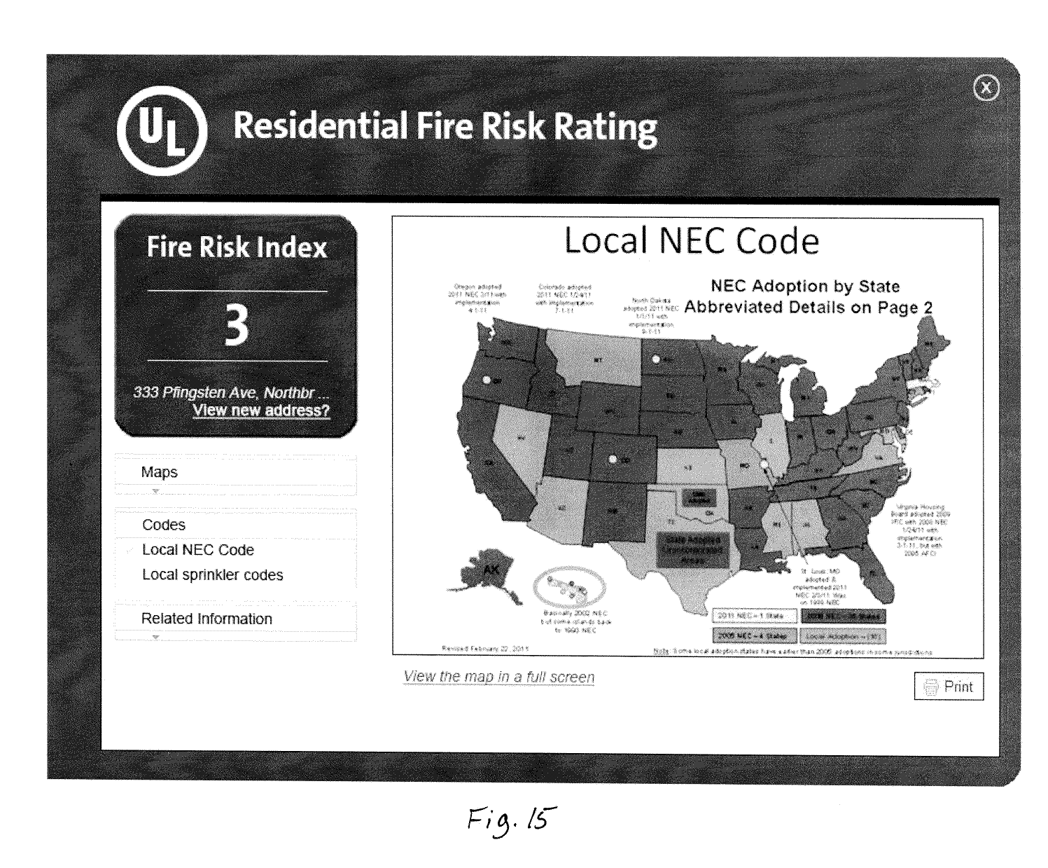

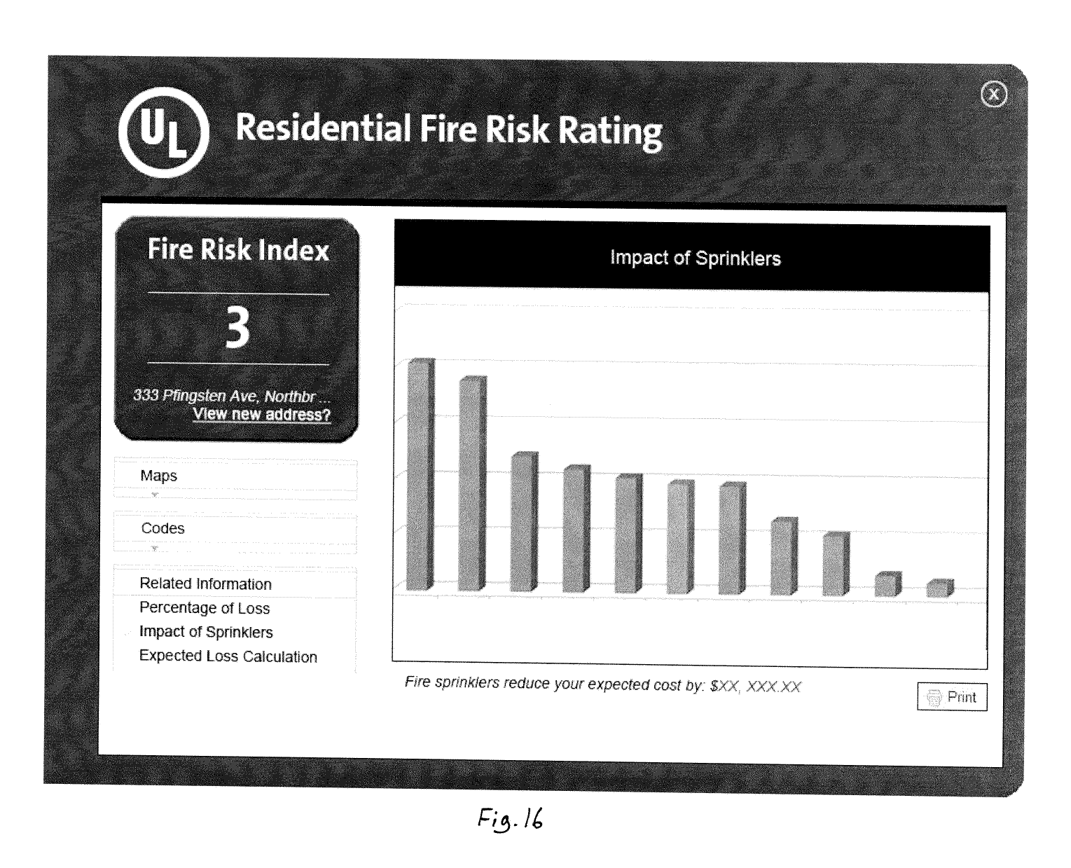

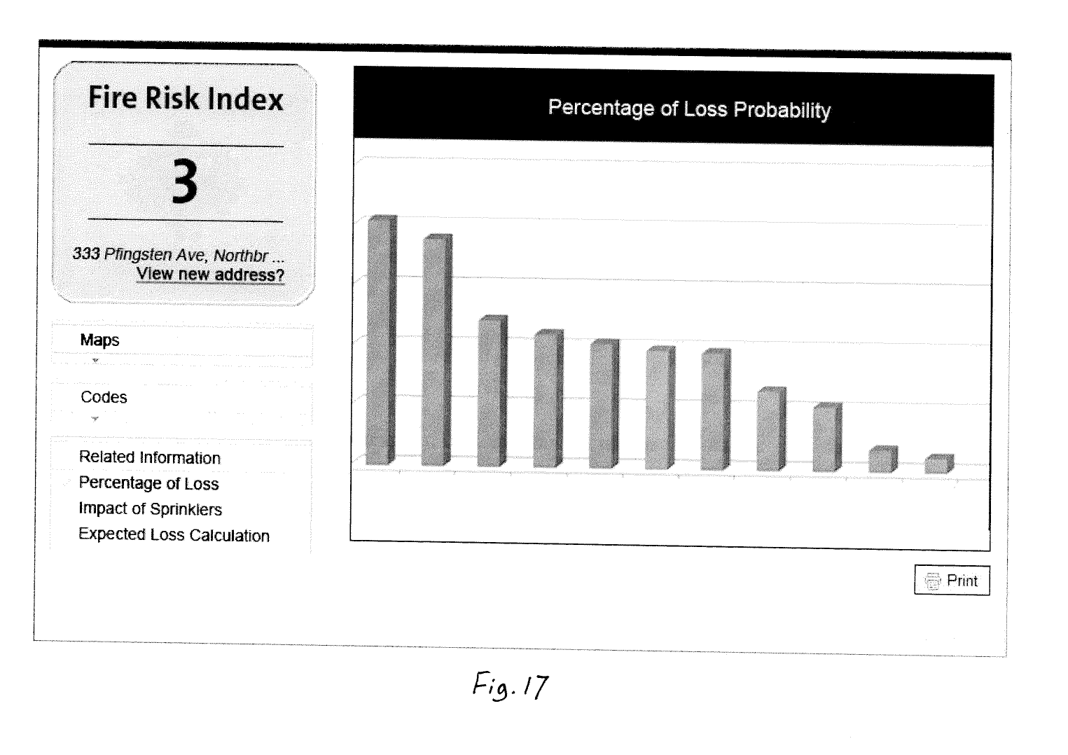

FIG. 7-17 illustrate exemplary screen shots of a method for determining a fire risk score.

This detailed description is to be construed as exemplary only and does not describe every possible embodiment, as describing every possible embodiment would be impractical, if not impossible. One could implement numerous alternate embodiments, using either current technology or technology developed after the filing date of this provisional patent application.

What is claimed is:

1. An historical based fire risk determination system comprising:
a program memory;
a processor;
a data source including a plurality of loss event records wherein each loss event record includes one or more material, demographic, geographic, or behavioral attributes contributing to a loss event;
a data source including real estate values;
a data source including map data;
a data source including data from the National Fire Incident Reporting System;
a data source including data from the National Fire Protection Association;
a data source including building data corresponding to a plurality of insurance applications, wherein each insurance application includes at least:
an address of a building,
an age of the building,
a size of the building,
an indication whether or not sprinklers are present in the building, and
an indication whether one or more smoke detectors in the building are remotely monitored;
wherein the program memory includes a risk analysis engine including instructions stored in the program memory that are executable by the processor to:
extract data from the data sources;
assign weights to the extracted building data;
identify one or more fire stations near an address of a building;
obtain or determine a driving time from the one or more fire stations to the building;
perform a statistical regression analysis to: at least the driving time from the one or more fire stations to the building, the age of the building and the size of the building to determine an expected loss to the building in the event of a fire, and
calculate a fire risk score for the building to assist an insurance company assess a risk of insuring the building.

2. The system according to claim 1, further comprising:
a data source including city and municipal building codes;
a data source including insurance claim data; and
a data source including state fire marshal data;

3. The system according to claim 1, wherein the instructions are further executable by the processor to extract data from fire department websites.

4. The system according to claim 1, wherein the instructions are further executable by the processor to determine a total response time as a sum of a time to detect a fire and call a 911 center, a time for the 911 center to send notify an appropriate fire station and a time for the notified fire station to arrive at the building.

5. The system according to claim 1, wherein the instructions are further executable by the processor to determine an expected loss index as a function of a time for a 911 center to notify an appropriate fire station, the age of the building and the size of the building.

6. The system according to claim 5, wherein the instructions are further executable by the processor to modulate the determined expected loss index when sprinklers are present in the building.

7. A method for determining a fire risk score, the method comprising:
extracting data from a plurality of data sources, wherein the data includes at least real estate values, map data, National Fire Incident Reporting System data, and building data, the building data including at least an address of a building, an age of the building, a size of the building, an indication whether or not sprinklers are present in the building, and an indication whether one or more smoke detectors in the building are remotely monitored;
assigning weights to the extracted building data;
identifying one or more fire stations near an address of the building;
obtaining or determining a driving time from the one or more fire stations to the building;
performing a statistical regression analysis to: at least the driving time from the one or more fire stations to the building, the age of the building and the size of the building to determine an expected loss to the building in the event of a fire, and
calculating a fire risk score for the building to assist an insurance company assess a risk of insuring the building.

8. The method according to claim 7, further comprising extracting data from:
a data source including city and municipal building codes;
a data source including insurance claim data; and
a data source including state fire marshal data;

9. The method according to claim 7, further comprising extracting data from fire department websites.

10. The method according to claim 7, further comprising determining a total response time as a sum of a time to detect a fire and call a 911 center, a time for the 911 center to send notify an appropriate fire station and a time for the notified fire station to arrive at the building.

11. The method according to claim 7, further comprising determining an expected loss index as a function of a time for a 911 center to notify an appropriate fire station, the age of the building and the size of the building.

12. The method according to claim 11, further comprising modulating the determined expected loss index when sprinklers are present in the building.

13. A method for determining a fire risk score, the method comprising:
extracting data from a plurality of data sources, wherein the data includes at least real estate values, map data, National Fire Incident Reporting System data, and building data, the building data including at least an address of a building, an age of the building, and a size of the building;
assigning weights to the extracted building data;
identifying one or more fire stations near an address of the building;
obtaining or determining a driving time from the one or more fire stations to the building;
performing a statistical regression analysis to: at least one of the driving time from the one or more fire stations to the building, the age of the building and the size of the building to determine an expected loss to the building in the event of a fire and calculate a fire risk score for the building to assist an insurance company assess a risk of insuring the building.

14. The method according to claim 13, further comprising extracting data from fire department websites.

15. The method according to claim 13, further comprising determining a total response time as a sum of a time to detect a fire and call a 911 center, a time for the 911 center to send notify an appropriate fire station and a time for the notified fire station to arrive at the building.

16. The method according to claim 13, further comprising determining an expected loss index as a function of a time for a 911 center to notify an appropriate fire station, the age of the building and the size of the building.

17. The method according to claim 16, further comprising determining if sprinklers are present in the building and modulating the determined expected loss index when sprinklers are present in the building.
